(19) United States
(12) Patent Application Publication
(10) Pub. No.: US 2011/0235817 A1
(43) Pub. Date: Sep. 29, 2011

(54) EARPHONE, ELECTRONIC SYSTEM AND POWER-SAVING METHOD

(75) Inventor: WEI-CHENG LIN, Tu-Cheng (TW)

(73) Assignee: HON HAI PRECISION INDUSTRY CO., LTD., Tu-Cheng (TW)

(21) Appl. No.: 12/770,769

(22) Filed: Apr. 30, 2010

(30) Foreign Application Priority Data
Mar. 25, 2010 (CN) 201010131946.3

(51) Int. Cl. H04R 3/00

(52) U.S. Cl. 381/74

(57) ABSTRACT

An electronic system includes an earphone and a host. The earphone comprises a temperature detector for detecting a temperature of an area around the earphone. The host connects to the earphone, and comprises an audio processing unit. The audio processing unit determines if the earphone is inserted into an ear of a user according to the temperature detected by the temperature detector, and enters into a normal working mode when the earphone is inserted into the ear of the user, or enters into a power-saving mode when the earphone is not inserted into the ear of the user.

### BACKGROUND

1. Technical Field

Embodiments of the present disclosure relate to electronic systems, and more particularly to an earphone, an electronic system, and a power-saving method.

2. Description of Related Art

People often use earphones in conjunction with electronic systems, such as MP3 players, MP4 players, personal digital assistants (PDAs), and notebook computers, so as to listen music and broadcasts.

However, a user must remove the earphones from his/her ears when he/she is listening to music played by a MP3 player using the earphones, when a mobile phone rings. In such a case, the user must remove the earphone from his/her ear to answer the mobile phone. The MP3 player and the earphone will consume much power if the user takes a long time on the mobile phone and forgets to turn off the MP3 player and the earphone.

Therefore, an improved earphone is needed to overcome the aforementioned deficiencies and inadequacies.

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 is a schematic diagram of an electronic system of one embodiment of the present disclosure;

FIG. 2 is a schematic diagram of modules of an earphone of one embodiment of the present disclosure;

FIG. 3 is a schematic diagram of function modules of the electronic system of one embodiment of the present disclosure;

FIG. 4 is a schematic diagram of actual components of the earphone of one embodiment of the present disclosure;

FIG. 5 is a schematic diagram showing a user wearing an earphone in accordance with one embodiment of the present disclosure;

FIG. 6 is a flowchart of a power-saving method of the earphone of the present disclosure; and

FIG. 7 is a flowchart of a power-saving method of the electronic system of the present disclosure.

### DETAILED DESCRIPTION

All of the processes described may be embodied in, and fully automated via, software code modules executed by one or more general purpose computers or processors. The code modules may be recorded in any type of computer-readable medium or other storage device. Some or all of the methods may alternatively be embodied in specialized computer hardware or communication apparatus.

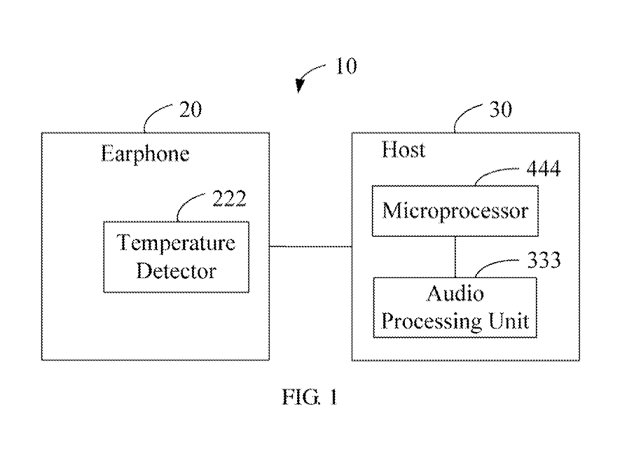

FIG. 1 is a schematic diagram of an electronic system 10 of one embodiment of the present disclosure. In one embodiment, the electronic system 10 includes an earphone 20 and a host 30. The host 30 may be a MP3 player, a MP4 player, a personal digital assistant (PDA) or a notebook computer, for example. The earphone 20 communicates with the host 30 via wired or wireless connections. As show in FIG. 1, the earphone 20 communicates with the host 30 via a wired connection. In another embodiment, the earphone 20 may communicate with the host 30 via a wireless connection, such as BLUETOOTH.

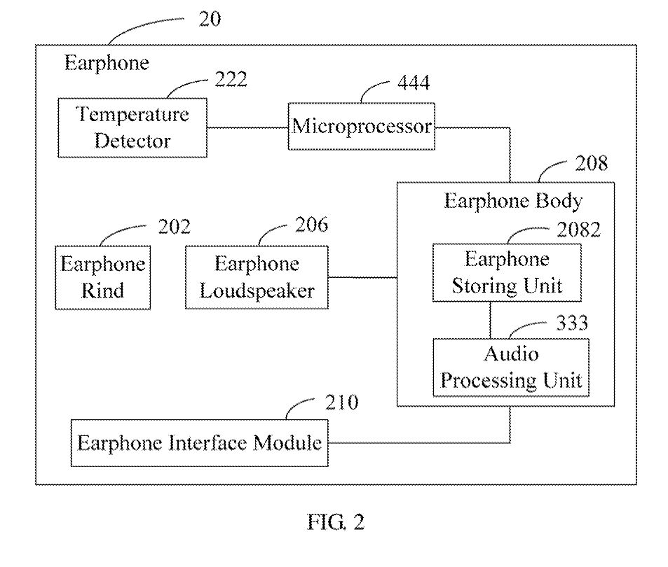

In one embodiment, the earphone 20 comprises a temperature detector 222, the host 30 comprises an audio processing unit 333 and a microprocessor 444. In one example, the temperature detector 222 is disposed in the earphone 20 to detect a temperature of an area around the earphone 20. The microprocessor 444 transmits a control signal to the audio processing unit 333 to make the audio processing unit 333 enter into a normal working mode or a power-saving mode according to the temperature detected by the temperature detector 222. In another embodiment, the audio processing unit 333 and the microprocessor 444 may be disposed in the earphone 20, as show in FIG. 2. In one embodiment, the earphone 20 and the host 30 works in a normal working mode or a power-saving mode.

FIG. 2 is a schematic diagram of modules of the earphone 20 of one embodiment of the present disclosure.

In one embodiment, the audio processing unit 333 and the microprocessor 444 are disposed in the earphone 20. The earphone 20 comprises an earphone rind 202, the temperature detector 222, the microprocessor 444, an earphone loudspeaker 206, an earphone body 208, and an earphone interface module 210.

The earphone body 208 comprises an earphone storing unit 2082 and the audio processing unit 333. The earphone storing unit 2082 stores a first temperature range according with normal human body temperature and a second temperature range according with environmental temperature. In one embodiment, as a normal human body temperature range is 36˜38, the first temperature range is 36˜38. In general, the environmental temperature range comprises an indoor temperature range and an outdoor temperature range, so the second temperature range according with environmental temperature is set based on a user's practical location. If the user is indoors, the second temperature range is set to an indoor temperature range, such as 23˜25. If the user is outdoors, the second temperature range is set to an outdoor temperature range, such as 13˜15.

The earphone rind 202 is operable to cover and protect the earphone loudspeaker 206 and the temperature detector 222.

The temperature detector 222 is operable to detect a temperature of an area around the earphone 20. In one embodiment, if the user wears the earphone 20, the temperature detected by the temperature detector 222 is close to human body temperature. If the user removes the earphone 20, the temperature detected by the temperature detector 222 is close to environmental temperature.

The microprocessor 444 transmits a control signal to the audio processing unit 333 according to the temperature detected by the temperature detector 222.

The audio processing unit 333 is operable to determine if the earphone 20 is inserted into an ear of a user according to the temperature detected by the temperature detector 222.

In one embodiment, if the temperature detected by the temperature detector 222 corresponds to the second temperature range, the audio processing unit 333 determines the earphone 20 is not inserted into the ear of the user. As the user removes the earphone 20, the audio processing unit 333 makes the earphone 20 enter into a power-saving mode, such as turning down a volume of the audio processing unit 333 or turning off the power of the earphone 20 to save power.

If the temperature detected by the temperature detector 222 corresponds to the first temperature range, the audio processing unit 333 determines the earphone 20 is inserted into the ear of the user and makes the earphone 20 enter into a normal working mode, such as turning on a volume of the audio processing unit 333.

The earphone interface module 210 communicating with the host 30 is operable to receive a digital audio signal from the host 30, transmit the temperature detected by the temperature detector 222 to the host 30, and transmit the digital audio signal to the audio processing unit 333. The audio processing unit 333 transforms the digital audio signal to an analog audio signal. The earphone loudspeaker 206 is operable to play the analog audio signal output from the audio processing unit 333.

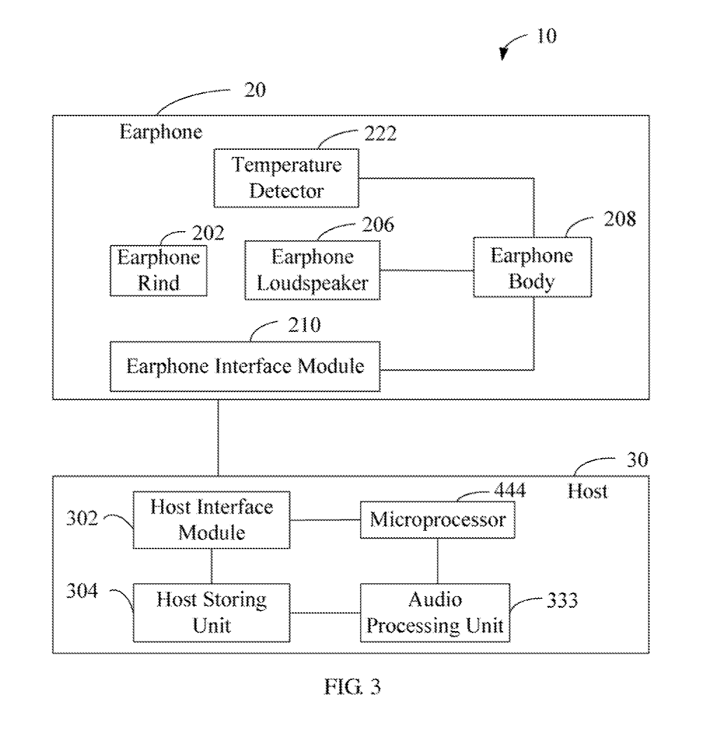

FIG. 3 is a schematic diagram of functional modules of the electronic system 10 of one embodiment of the present disclosure. As show in FIG. 3, both the audio processing unit 333 and the microprocessor 444 are disposed in the host 30.

In one embodiment, the electronic system 10 comprises the earphone 20 and the host 30. The earphone 20 comprises the earphone rind 202, the temperature detector 222, the earphone loudspeaker 206, the earphone body 208, and the earphone interface module 210. In one embodiment, the earphone body 208 does not comprise the earphone storing unit 2082 and the audio processing unit 333.

The host 30 comprises a host interface module 302, a host storing unit 304, the audio processing unit 333, and the microprocessor 444.

The host interface module 302 is operable to receive the temperature detected by the temperature detector 222 from the earphone interface module 210 and transmit the digital audio signal output from the audio processing unit 333 to the earphone 20. In one embodiment, the type of the host interface module 302 is the same as the type of the earphone interface module 210. The host interface module 302 and the earphone interface module 210 may be BLUETOOTH interfaces or wired interfaces, for example.

The host storing unit 304 is operable to store the first temperature range according with normal human body temperature and the second temperature range according with environmental temperature. In one embodiment, as the normal human body temperature range is 36˜38, the first temperature range is 36˜38. In general, the environmental temperature range comprises the indoor temperature range and the outdoor temperature range, so the second temperature range according with environmental temperature is set based on the user's practical location. If the user is indoor, the second temperature range is set to the indoor temperature range, such as 23˜25. If the user is outdoor, the second temperature range is set to the outdoor temperature range, such as 13˜15.

The temperature detector 222 is operable to detect the temperature of an area around the earphone 20 and transmit the temperature to the host interface module 302 via the earphone interface module 210.

The microprocessor 444 transmits the control signal to the audio processing unit 333 according to the temperature detected by the temperature detector 222.

The audio processing unit 333 is operable to determine if the earphone 20 is inserted into the ear of the user after receive the control signal from the microprocessor 444.

In one embodiment, the audio processing unit 333 determines if the earphone 20 is inserted into the ear of the user according to the temperature detected by the temperature detector 222.

If the temperature detected by the temperature detector 222 corresponds to the second temperature range, the audio processing unit 333 determines the earphone 20 is not inserted into the ear of the user. As the user removes the earphone 20, the audio processing unit 333 makes the host 30 enter into the power-saving mode, such as turning down the volume of the audio processing unit 333 or turning off the power of the host 30 to save power.

If the temperature detected by the temperature detector 222 corresponds to the first temperature range, the audio processing unit 333 determines the earphone 20 is inserted into the ear of the user and makes the host 30 enter into the normal working mode, such as turning on the volume of the audio processing unit 333.

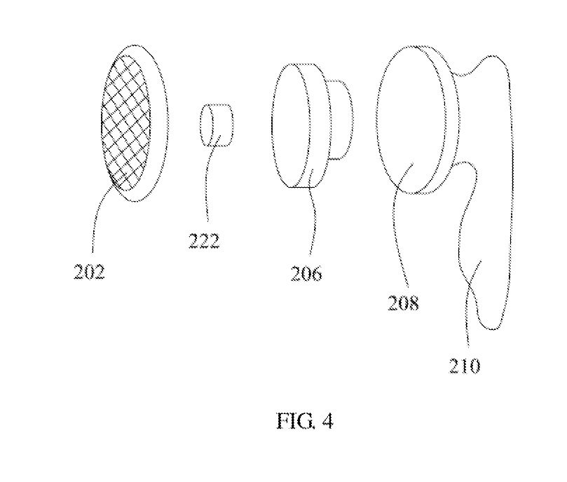

FIG. 4 is a schematic diagram of actual components of the earphone 20 of one embodiment of the present disclosure. As show in FIG. 4, the earphone 20 comprises the earphone rind 202, the temperature detector 222, the earphone loudspeaker 206, the earphone body 208, and the earphone interface module 210 in sequence. In one embodiment, the earphone storing unit 2082 and the audio processing unit 333 may be disposed in the earphone body 208.

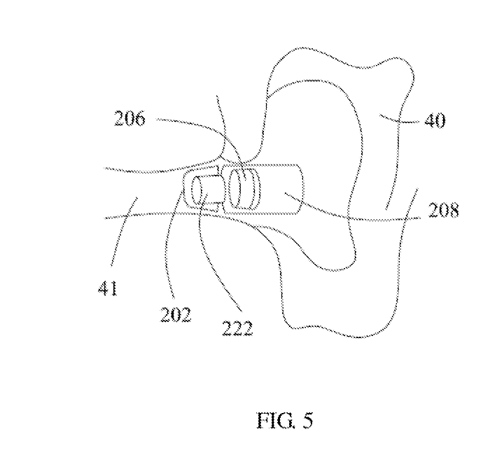

FIG. 5 is a schematic diagram showing the user wearing the earphone 20 in accordance with one embodiment of the present disclosure. The ear of the user 40 and auricle 41 are shown in FIG. 5. The earphone rind 202, temperature detector 222, and the earphone body 208 form cooperatively an inner earphone that is inserted into the user's auricle 41.

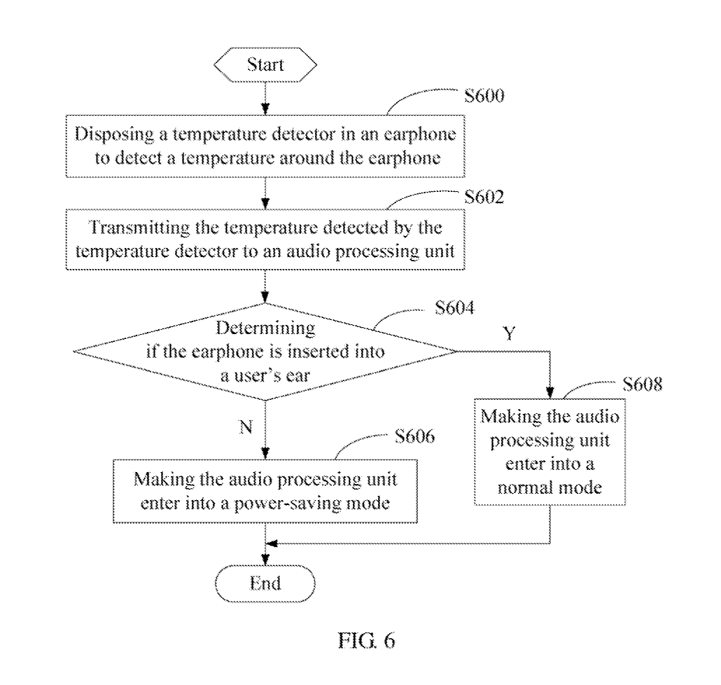

FIG. 6 is a flowchart of a power-saving method of the earphone 20 of the present disclosure. The power-saving method is executed via the functional modules of the earphone 20 in FIG. 2. Depending on the embodiment, additional blocks may be added, others deleted, and the ordering of the blocks may be changed while remaining well within the scope of the disclosure.

In block S600, the temperature detector 222 is disposed in the earphone 20 to detect the temperature of an area around the earphone 20, as show in FIG. 2.

In block S602, the temperature detector 222 detects the temperature of an area around the earphone 20 and transmits the temperature to the audio processing unit 333.

In block S604, the audio processing unit 333 determines if the earphone 20 is inserted into the ear of the user according to the temperature detected by the temperature detector 222. In one embodiment, the audio processing unit 333 determines if the earphone 20 is inserted into the ear of the user according to the temperature detected by the temperature detector 222.

If the temperature detected by the temperature detector 222 corresponds to the second temperature range, the audio processing unit 333 determines the earphone 20 is not inserted into the ear of the user, then in block S606, the audio processing unit 333 makes the audio processing unit 333 enter into the power-saving mode, such as turning down the volume of the audio processing unit 333 or turning off the power of the earphone 20 to save power.

If the temperature detected by the temperature detector 222 corresponds to the first temperature range, the audio processing unit 333 determines the earphone 20 is inserted into the ear of the user, then in block S608, the audio processing unit 333 makes the audio processing unit 333 enter into the normal working mode, such as turning on the volume of the audio processing unit 333.

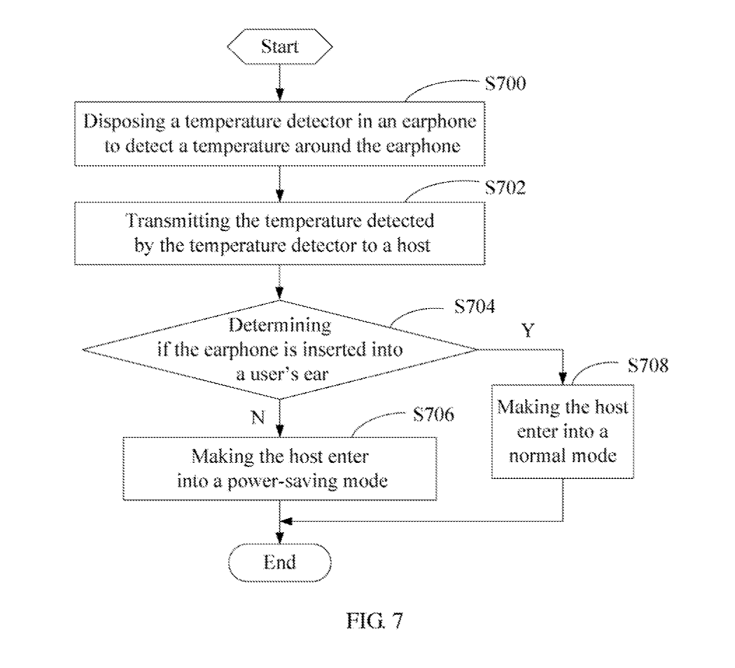

FIG. 7 is a flowchart of a power-saving method of the electronic system 10 of the present disclosure. The power-saving method is executed via the functional modules of the electronic system 10 in FIG. 3. Depending on the embodiment, additional blocks may be added, others deleted, and the ordering of the blocks may be changed while remaining well within the scope of the disclosure.

In block S700, the temperature detector 222 is disposed in the earphone 20 to detect the temperature of an area around the earphone 20.

In block S702, the temperature detector 222 detects the temperature of an area around the earphone 20 and transmits the temperature to the audio processing unit Page of 333. In one embodiment, the temperature detected by the temperature detector 222 transmits from the earphone interface module 210 to the host interface module 302.

In block S704, the audio processing unit 333 determines if the earphone 20 is inserted into the ear of the user according to the temperature detected by the temperature detector 222.

In one embodiment, if the temperature detected by the temperature detector 222 corresponds to the second temperature range, the audio processing unit 333 determines the earphone 20 is not inserted into the ear of the user, then in block S706, the audio processing unit 333 makes the host 30 enter into the power-saving mode, such as turning down a volume of the audio processing unit 333 or turning off the power of the host 30 to save power.

If the temperature detected by the temperature detector 222 corresponds to the first temperature range, the audio processing unit 333 determines the earphone 20 is inserted into the ear of the user, then in block S708, the audio processing unit 333 makes the host 30 enter into the normal working mode, such as turning on the volume of the audio processing unit 333.

In one embodiment, the electronic system 10 determines if the earphone 20 is inserted into the ear of the user according to the temperature detected by the temperature detector 222, and makes the electronic system 10 enter into the power-saving mode when the earphone 20 is not inserted into the ear of the user to save power.

While various embodiments and methods of the present disclosure have been described, it should be understood that they have been presented by example only and not by limitation. Thus the breadth and scope of the present disclosure should not be limited by the above-described embodiments, but should be defined only in accordance with the following claims and their equivalents.

What is claimed is:

1. An earphone in communication with a host, the earphone comprising:
a temperature detector operable to detect a temperature of an area around the earphone; and
an audio processing unit operable to determine if the earphone is inserted into an ear of a user according to the temperature detected by the temperature detector, and enter into a normal working mode when the earphone is inserted into the ear of the user, or enter into a power-saving mode when the earphone is not inserted into the ear of the user.

2. The earphone as claimed in claim 1, further comprising:
an earphone storing unit operable to store a first temperature range according with normal human body temperature and a second temperature range according with environmental temperature.

3. The earphone as claimed in claim 2, wherein the audio processing unit is further operable to determine if the earphone is inserted into the ear of the user according to the temperature detected by the temperature detector;
wherein the audio processing unit determines the earphone is inserted into the ear of the user when the temperature detected by the temperature detector corresponds to the first temperature range; or
the audio processing unit determines the earphone is not inserted into the ear of the user when the temperature detected by the temperature detector corresponds to the second temperature range.

4. The earphone as claimed in claim 2, further comprising:
an earphone interface module operable to receive a digital audio signal from the host and transmit the digital audio signal to the audio processing unit, wherein the audio processing unit transforms the digital audio signal to an analog audio signal;
an earphone loudspeaker operable to play the analog audio signal output from the audio processing unit; and
an earphone rind operable to cover and protect the earphone loudspeaker and the temperature detector.

5. The earphone as claimed in claim 4, wherein the audio processing unit is further operable to change a volume of the analog audio signal and enter into the power-saving mode when the earphone is not inserted into the ear of the user.

6. An electronic system, comprising:
an earphone comprising a temperature detector operable to detect a temperature of an area around the earphone; and
a host communicated with the earphone, comprising an audio processing unit operable to determine if the earphone is inserted into an ear of a user according to the temperature detected by the temperature detector, and enter into a normal working mode when the earphone is inserted into the ear of the user, or enter into a power-saving mode when the earphone is not inserted into the ear of the user.

7. The electronic system as claimed in claim 6, wherein the host further comprises a host storing unit operable to store a first temperature range according with normal human body temperature and a second temperature range according with environmental temperature.

8. The electronic system as claimed in claim 7, wherein the audio processing unit is further operable to determine if the earphone is inserted into the ear of the user according to the temperature detected by the temperature detector;
wherein the audio processing unit determines the earphone is inserted into the ear of the user when the temperature detected by the temperature detector corresponds to the first temperature range; or
the audio processing unit determines the earphone is not inserted into the ear of the user when the temperature detected by the temperature detector corresponds to the second temperature range.

9. The electronic system as claimed in claim 6, wherein the host further comprises a host interface module operable to transmit an analog audio signal provided by the audio processing unit to the earphone.

10. The electronic system as claimed in claim 9, wherein the earphone further comprises an earphone interface module operable to receive the analog audio signals from the audio processing unit, and the earphone further comprises an earphone loudspeaker operable to play the analog audio signals.

11. The electronic system as claimed in claim 7, wherein the audio processing unit is further operable to change a volume of the analog audio signal and enter into the power-saving mode when the earphone is not inserted into the ear of the user.

12. A power-saving method of an electronic system, the electronic system comprising an earphone and a host communicated with the earphone, the power-saving method comprising:
detecting a temperature of an area around the earphone using a temperature detector disposed in the earphone;
transmitting the temperature detected by the temperature detector to the host;
determining if the earphone is inserted into an ear of a user according to the temperature detected by the temperature detector; and
making the host enter into a normal working mode when the earphone is inserted into the ear of the user; or
making the host enter into a power-saving mode when the earphone is not inserted into the ear of the user.

13. The power-saving method as claimed in claim 12, wherein the block of determining if the earphone is inserted into the ear of the user according to the temperature detected by the temperature detector comprises:
storing a first temperature range according with normal human body temperature and a second temperature range according with environmental temperature;
determining the earphone is inserted into the ear of the user when the temperature detected by the temperature detector corresponds to the first temperature range; and
determining the earphone is not inserted into the ear of the user when the temperature detected by the temperature detector corresponds to the second temperature range.

14. The power-saving method as claimed in claim 12, wherein the block of making the host enter into a power-saving mode comprises:
changing a volume of an analog audio signal output from the host and entering into the power-saving mode when the earphone is not inserted into the ear of the user.
